(19) United States
(12) Patent Application Publication
(10) Pub. No.: US 2025/0101799 A1
(43) Pub. Date: Mar. 27, 2025

(54) ROLLING SHUTTER DOOR RAILING

(71) Applicant: GUANGZHOU TUSUNNY HOME PRODUCTS CO., LTD, Guangzhou (CN)

(72) Inventor: HONGJUAN WANG, Guangzhou (CN)

(21) Appl. No.: 18/772,527

(22) Filed: Jul. 15, 2024

(30) Foreign Application Priority Data
Sep. 21, 2023 (CN) 202311230794.6

(51) Int. Cl. E06B 9/17; E06B 9/58; E06B 9/80

(52) U.S. Cl. CPC E06B 9/17; E06B 9/58; E06B 9/80; E06B 2009/805

(57) ABSTRACT

The present invention discloses a rolling shutter door railing, including a connecting mechanism for connecting with the free end of rolling shutter, the connecting mechanism includes a column and a seat on the column, the column can be vertically fixed to the installation position through the seat, and the length of the column fits the overall height of the rolling shutter door railing; the simple structure in the present invention can be directly installed, without any positioning installation based on the position of the rolling shutter. Compared to traditional structures, the present invention has optimized the installation process and effectively improved the installation convenience of rolling shutter door railing.

### CROSS-REFERENCE TO RELATED APPLICATIONS

This application claims priority to Chinese Patent Application No. 202311230794.6, filed on Sep. 21, 2023, which is hereby incorporated by reference in its entirety.

### TECHNICAL FIELD

The present invention relates to the field of door railing technology, in particular to a rolling shutter door railing.

### BACKGROUND

In families with infants, in order to protect infants walking out of the room against accidents such as getting lost or personal injury, people often install a telescopic door railing in positions like doors, stairwells or corridors and the like.

The Chinese patent application number CN202320165782.9, for example, discloses an adjustable telescopic protective door railing, mainly including an upper fixed seat, a lower fixed seat, a rolling shutter component, reel and the like, and the reel can be pivotally installed between the upper fixed seat and the lower fixed seat, and the rolling shutter component's shutter body is installed on the reel and can be pulled out for use and, when not in use, can be retracted in place by driving the reel to rotate under the elastic torsion action of the spring. The free end of the roller shutter (i.e. the end away from the reel) is provided with two hooks that are vertically spaced apart and, after the installation of the telescopic door railing, two buckles need to be installed in another installation position, and the two buckles should have a height consistent with that of the two hooks so that, after the roller shutter is pulled out, the roller shutter can be fixed through the connection between the two buckles and two hooks, and the roller shutter can be retracted as long as the fit between the buckle and hook is released.

The reason for the troublesome installation of buckles is that, in order to maintain the flatness of roller shutter, usually two buckles are used, and need to be positioned and installed according to the height and position of the hooks and, after the buckles are installed, there is often a height difference between the hooks and the buckles, causing the fastening failure due to the misalignment between the buckles and hooks, and the buckles has to be repositioned and installed.

Accordingly, the applicant believes that it is urgent to propose a connection mechanism that can be directly installed, without the need for positioning and installation based on the position of roller shutter.

### SUMMARY

The main purpose of the present invention is to propose a rolling shutter door railing to address the problems proposed in the background art mentioned above.

To achieve the above purpose, the present invention proposes a rolling shutter door railing, including an upper support, a lower support, a reel that can be pivotally installed between the upper support and the lower support, and a rolling shutter located on the reel, also including a connecting mechanism for connecting to the free end of rolling shutter, the connecting mechanism includes a column having a seat body for connecting to the installation position, and the column can be vertically fixed to the installation position through the seat, and the connecting mechanism also has a locking mechanism for locking the free end of rolling shutter.

The technical solution of the present invention includes a connecting mechanism for connecting with the free end of rolling shutter, the connecting mechanism includes a column and a seat on the column, the column can be vertically fixed to the installation position through the seat, and the length of the column fits the overall height of the rolling shutter door railing and, of course, can also be longer and therefore, during installation, the connecting mechanism can be directly installed in any position without positioning, and after the rolling shutter is pulled out, the free end of rolling shutter can be directly connected to the column or seat and then locked by the locking mechanism; the simple structure in the present invention can be directly installed, without any positioning installation based on the position of the rolling shutter. Compared to traditional structures, the present invention has optimized the installation process and effectively improved the installation convenience of rolling shutter door railing.

### BRIEF DESCRIPTION OF DRAWINGS

FIG. 1 is a 3D view of the present invention;

FIG. 2 is an assembly diagram of the upper connecting seat, lower connecting seat, and support rod;

FIG. 3 is a 3D view of the upper connecting seat, lower connecting seat, and moving seat;

FIG. 4 is a sectional view of the upper connecting seat;

FIG. 5 is an exploded view of the upper connecting seat;

FIG. 6 is an exploded view of the moving seat.

### DETAILED DESCRIPTION OF THE EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, back, top, bottom, inside, outside, vertical, horizontal, vertical, counterclockwise, clockwise, circumferential, radial, axial . . . ) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present invention.

The present invention proposes a rolling shutter door railing.

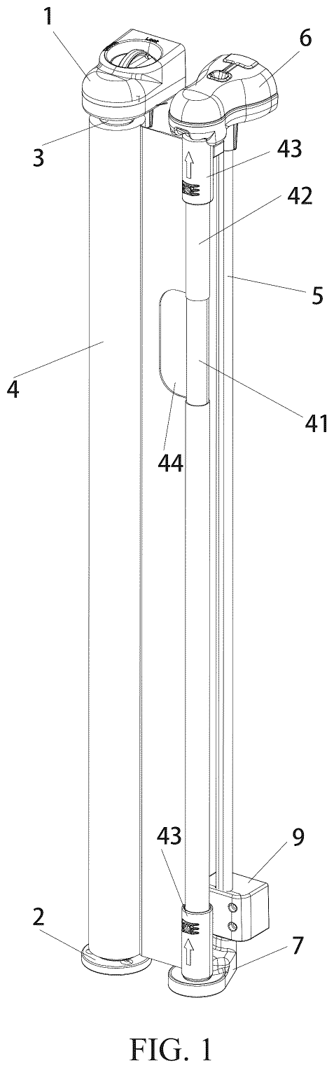

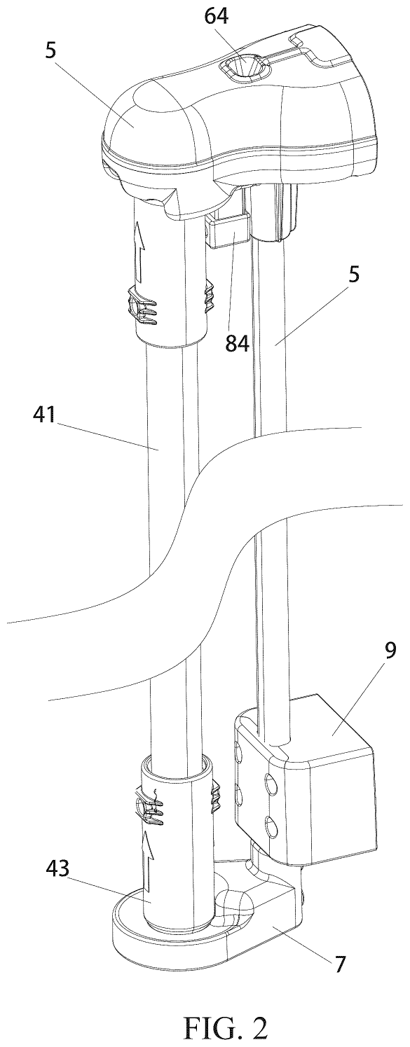

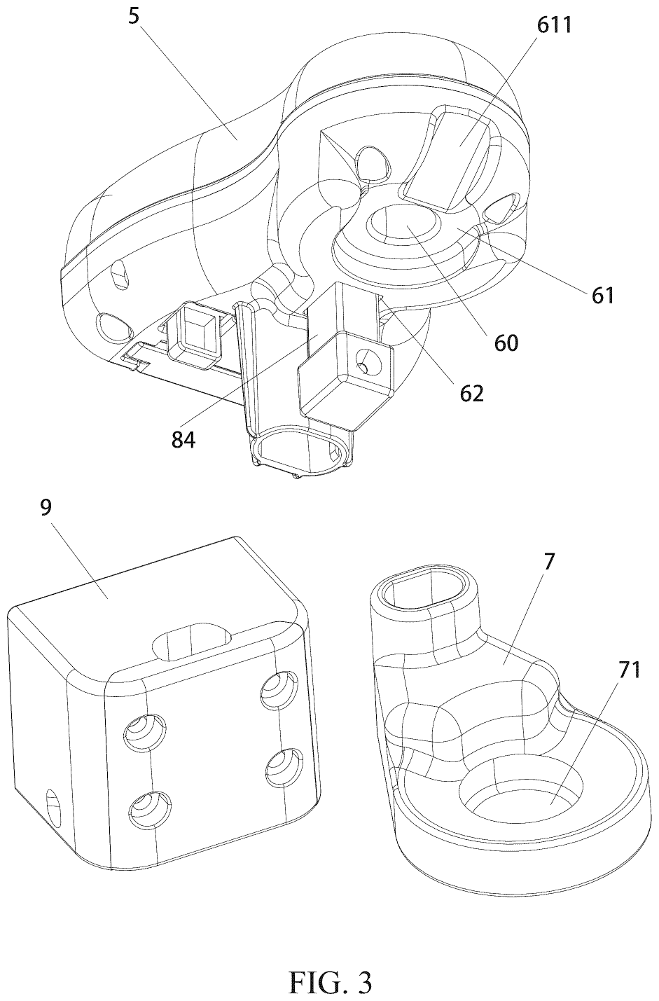

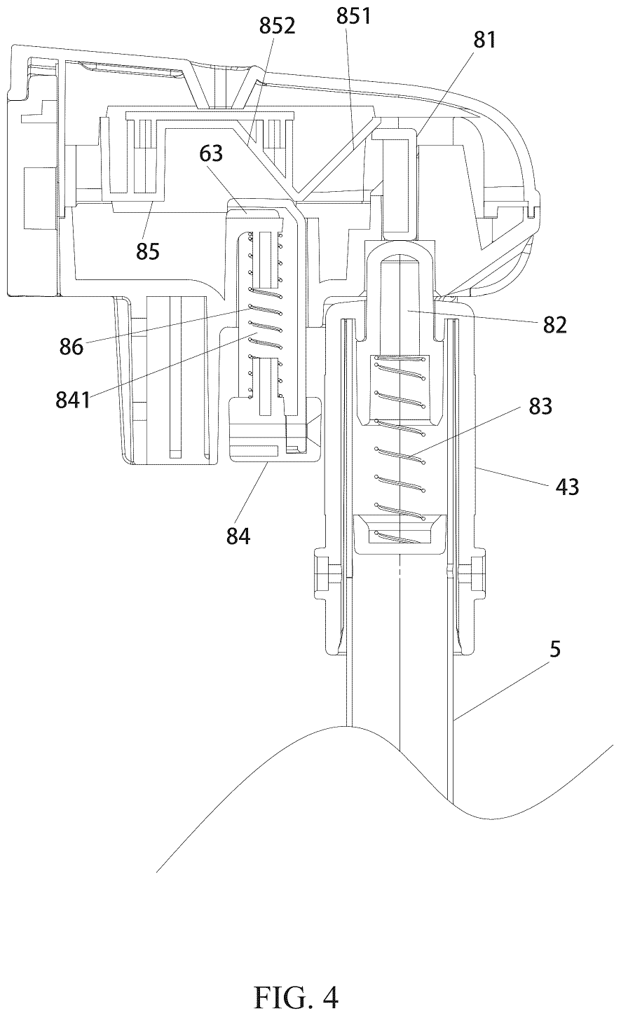

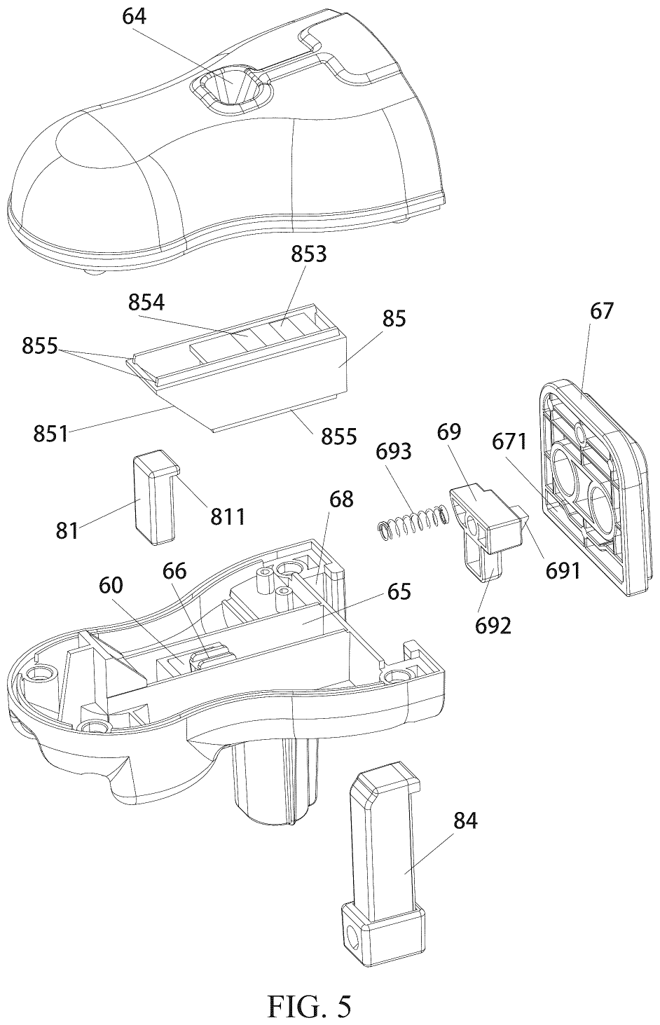

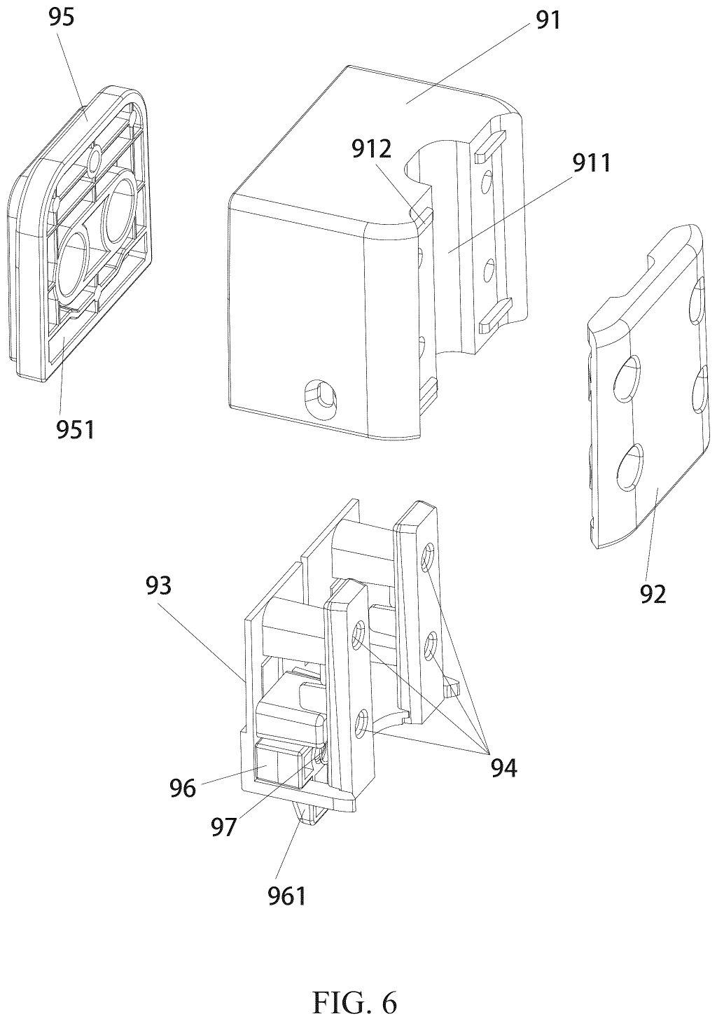

In the embodiments of the present invention, as shown in FIGS. 1 to 6, the rolling shutter door railing includes an upper support 1, a lower support 2, a reel 3 that can be pivotally installed between the upper support 1 and the lower support 2, and a rolling shutter 4 located on the reel 3, also includes a connecting mechanism for connecting to the free end of rolling shutter 4, the connecting mechanism includes a column 5 having a seat body for connecting to the installation position, and the column 5 can be vertically fixed to the installation position through the seat, and the connecting mechanism also has a locking mechanism for locking the free end of rolling shutter.

The technical solution of the present invention includes a connecting mechanism for connecting with the free end of rolling shutter, the connecting mechanism includes a column and a seat on the column, the column can be vertically fixed to the installation position through the seat, and the length of the column fits the overall height of the rolling shutter door railing and, of course, can also be longer and therefore, during installation, the connecting mechanism can be directly installed in any position without positioning, and after the rolling shutter is pulled out, the free end of rolling shutter can be directly connected to the column or seat and then locked by the locking mechanism; the simple structure in the present invention can be directly installed, without any positioning installation based on the position of the rolling shutter. Compared to traditional structures, the present invention has optimized the installation process and effectively improved the installation convenience of rolling shutter door railing.

Specifically, the free end of the roller shutter 4 can be detachably connected to the pillar 5 or the connecting seat and, in this embodiment, the free end of roller shutter 4 is detachably connected to the pillar 5, and a hook that can be hooked with the pillar 5 is provided at the free end of roller shutter 4 and, after roller shutter 4 is pulled out, the free end of roller shutter 4 can be fixed by the hook of pillar 5; in order to strengthen the connection between the free end of roller shutter 4 and the connecting mechanism, and avoid easy separation between the hook and the column 5, the locking structure in the prior art, such as screw locking, fixing by buckle structure, can be used to lock the hook and column 5 after the hook and column 5 are hooked, and the specific structural principle is not elaborated here. Of course, in this embodiment, the hook can also be replaced by items such as straps, buckles, and ropes with Velcro.

In this embodiment, the free end of the roller shutter 4 is provided with a support rod 41, and the seat body includes an upper connecting seat 6 and a lower connecting seat 7 respectively disposed at the top and bottom of support rod 5, the bottom of upper connecting seat 6 and the top of lower connecting seat 7 are respectively provided with a first slot 61 for the insertion of the top of support rod 41 and a second groove 71 for the insertion of the bottom of support rod 41, the locking mechanism is used to lock the support rod 41 with the seat body after the top and bottom of the support rod 41 are respectively inserted into the first slot 61 and the second slot 71.

Specifically, the upper connecting seat 6, lower connecting seat 7, and the column 5 are an integrated structure or a detachable connecting structure and, in a detachable connecting structure, the upper connecting seat 6 and lower connecting seat 7 are respectively inserted into the top and bottom of the column 5 and locked by screws or fixed by a buckle structure.

Specifically, the locking mechanism includes a first slider 81, and the top wall of the first slot 61 is provided with a vertical extending accommodating groove 60 that fits the first slider 81, the first slider 81 is movably installed in the accommodating groove 60 and can perform vertical reciprocating motion relative to the accommodating groove 60.

In an embodiment, the top of the support rod 41 is provided with a locking hole, and after the top of support rod 41 is inserted into the first slot 61, the locking hole is aligned up and down with the first slider 81. To install support rod 41, first insert the bottom of support rod 41 into the second slot 71, and then insert the top of support rod 41 into the first slot 61 and, after aligning the locking hole with the first slider 81 up and down, the support rod 41 descends to the bottom of the first slider 81 and inserts into the locking hole, so that the top end of support rod 41 cannot exit the first slot 61, thereby the top end of support rod 41 is locked with the upper connecting seat 6, and since the top end of support rod 41 is locked, the bottom of support rod 41 cannot exit the second slot 71, thus locking the support rod 41 with the seat body; the locking between support rod 41 and seat body can be unlocked when the first slider 81 rises and the lower end of first slider 81 exits the locking hole. In this embodiment, the first slider 81 has a large length. As for how to drive the first slider 81 to perform vertical reciprocating motion in this embodiment, a driving member connected to the first slider 81 can be provided on the upper connecting seat 6, and the driving member can be manually controlled to drive the first slider 81 to perform vertical reciprocating motion. Of course, reference can also be made to prior art for the driving structure, which will not be further elaborated here.

In this embodiment, a locking member 82 is movably provided at the top of support rod 41, and the locking member 82 can move between the position where it retracts inside support rod 41 and the position where it extends into the accommodating groove 60 to force the first slider 81 to rise, and the support rod 41 is internally provided with a first top spring 83 connected to the locking member 82, and the first top spring 83 applies elastic force to the locking member 82 so that the first slider 81 can move upward. To install the support rod 41, first insert the bottom of support rod 41 into the second slot 71, and then clip the top of support rod 41 into the first slot 61, the locking member 82 can be forced by external force, such as manual pressing, into the interior of support rod 41 and simultaneously the top of support rod 41 can be snapped into the first slot 61 and, alternatively, during the snap-fit process, the pressure generated when the outer wall of upper connecting seat 6 contacts the locking member 82 forces locking member 82 automatically retreat into the interior of support rod 41; the top of support rod 41 is snapped into the first slot 61, and the external force applied to the locking member 82 disappears, the elastic force applied by the first top spring 83 forces the locking member 82 to extend into the accommodating groove 60 and jack up the first slider 81, the locking member 82, when located in the accommodating groove 60, can restrict the top of support rod 41 from exiting the first slot 61, thereby locking the upper end of support rod 41 with the upper connecting seat 6, and the bottom of support rod 41 cannot exit the second slot 71 since the top of the support rod 41 is locked, so that the support rod 41 and the seat body are locked. The first slider 81 descends to come into contact with the locking member 82 and forces the locking member 82 to retreat into the support rod 41 and, after the top of support rod 41 is unlocked, the top of support rod 41 can be taken out from the first slot 61 and then the bottom of support rod 41 can be taken out from the second slot 71 to disassemble the support rod 41 from the connecting mechanism.

Specifically, in this embodiment, the locking mechanism further includes a second slider 84 and a third slider 85, the second slider 84 is movably installed at the bottom of upper connecting seat 6 and can perform vertical reciprocating motion relative to the upper connecting seat 6, and the upper end of the second slider 84 is located inside the upper connecting seat 6, the third slider 85 is movably installed inside the upper connecting seat 6, and the side of the third slider 85 near the first slider 81 and the side of the third slider 85 near the second slider 84 are respectively provided with a first inclined plane 851 for contact with the first slider 81 and with a second inclined plane 852 for contact with the the top of the second slider 84, the first inclined plane 851 and the second inclined plane 852 have the opposite inclination direction, and the third slider 85 can move between the position where the first slider 81 is forced through the first slope 851 to perform a downward motion and the position where the second slider 84 is forced through the second slope 852 to perform a downward motion. When the second slider 84 is pressed by external forces, such as manual pressing, to perform an upward movement, the upper end of second slider 84 contacts the second inclined plane 852 and, through the second inclined plane 852, forces the third slider 85 to move in the direction of the first slider 81 and, during the movement, the upper end of first slider 81 contacts the first inclined plane 851 and, through the first inclined plane 851, forces the first slider 81 to perform a downward movement to cause the locking member 82 to retreat into the interior of support rod 41; on the contrary, when the locking member 82 forces the first slider 81 to perform an upward movement, the upper end of the first slider 81 contacts the first inclined plane 851 and, through the first inclined plane 851, forces the third slider 85 to move in the direction of the second slider 84, thus restoring the third slider 85.

Specifically, a guide groove 841 is provided on one side of the second slider 84, and a through groove 62 is provided at the bottom of upper connecting seat 6 for the second slider 84 to vertically pass through, the through groove 62 is connected to the interior of upper connecting seat 6, and a first limit portion 63 that can extend into the guide groove 841 is provided in the through groove 62, and the first limit portion 63 can maintain contact with the top of guide groove 841 to limit second slider 84 to detach from the through groove 62.

Specifically, a second top spring 86 is provided in the guide groove 841, and the upper and lower ends of the second top spring 86 are respectively pressed against the bottom wall of upper connecting seat 6 and the bottom wall of guide groove 841, the second top spring 86 can be used to apply elastic force to the second slider 84 so that the second slider 84 can move to exit the through groove 62.

Specifically, columnar bodies are provided on one side of the first limit portion 63 near the second top spring 86 and on the bottom wall of the guide groove 841, and the upper and lower ends of the second top spring 86 are respectively sleeved on the two columnar bodies.

Specifically, the top wall of the third slider 85 is provided with a first mark 853 and a second mark 854 that are disposed adjacently, and the top wall of the upper connecting seat 6 is provided with an observation window 64 that is connected with the interior of upper connecting seat 6, and when the third slider 85 moves to push the locking member 82 into the support rod 41, the first mark 853 is aligned up and down with the observation window 64; the third slider 85 moves until the locking member 82 extends into the accommodating groove 60, and then the second mark 854 is aligned up and down with the observation window 64.

Specifically, bottom-open and top-open moving channels 65 are respectively provided inside the upper connecting seat 6 corresponding to the positions above and below the third slider 85, the top and bottom walls of the third slider 85 are provided with guiding portions 855 that can insert the two moving channels 65 respectively, and the third slider 85 can move along the moving channel 65 based on the cooperation between the guiding portion 855 and the moving channel 65.

Specifically, the first slot 61 is provided with a pressure groove 611 that is partially open for the top of support rod 41 to pass through and that has a slanted extended pressure groove 611 at the open position and, when the support rod (41) passes through the open position, the pressure groove 611 can be used to gradually push the locking member 82 into the interior of support rod 41.

Specifically, a locking position 66 is provided inside the upper connecting seat 6 corresponding to the top of accommodating groove 60, and a second limit portion 811 is provided at the top of the first slider 81 that can be pressed against with the locking position 66 up and down to prevent the complete entry of first slider 81 into the accommodating groove 60.

Specifically, in the embodiment, the first slider 81 can also be in contact with the first inclined plane 851 through the first limit portion 63.

Specifically, the edge of the free end of roller shutter 4 is provided with a kit 42 for wrapping the support rod 41, and a cap body 43 is additionally provided for the end of support rod 41 to insert and, after the kit 42 wraps the support rod 41, the cap body 43 will wrap and fix the top of support rod 41 and of kit 42, and wrap and fix the bottom of support rod 41 and of kit 42.

Specifically, the kit 42 and roller shutter 4 are of integrated or split structure, and if they are of an integrated structure, the kit 42 is formed by the edge of free end of roller shutter 4 that is bent and then fixed; if they are of a split structure, the kit 42 is fixed to the edge of the free end of roller shutter 4 by glue, needle and thread stitching, or by a buckle structure.

Specifically, the two ends of support rod 41 are provided with the cap body 43, and an avoidance hole (not shown in the figure) is provided at the position of cap body 43 corresponding to the roller shutter 4 for the roller shutter 4 to pass through.

Specifically, a window 44 for easy gripping of support rod 41 is provided at the free end of roller shutter 4 near the support rod 41. When the roller shutter 4 is pulled out, the avoidance effect of the window 44 allows the palm to fully grasp the support rod 41, avoiding the automatic retraction of roller shutter 4 due to insufficient grasping position of the support rod 41 when the roller shutter 4 is being pulled out.

Specifically, the back of the upper connecting seat 6 is fixed by double-sided adhesive or locked in the installation position by screws, or the following embodiments can be referred to: the upper connecting seat 6 is detachably provided with a first plug board 67 for fixing in the installation position (for example, by double-sided adhesive or screws), the back of upper connecting seat 6 is provided with a first slot 68 for the bottom-top insertion of the first plug board 67, the first slot 68 is movably provided with a first locking key 69 having a first locking portion 691 and a first driving portion 692, the first plug board 67 is provided with a first locking position 671 for the insertion of first locking portion 691, and after the first plug board 67 is inserted into the first slot 68, the first locking portion 691 is inserted into the first locking position 671 to limit the first plug board 67 from exiting the first slot 68, and a third top spring 693 is additionally provided to apply elastic force to make the first locking key 69 to move towards the direction in which the first locking portion 691 is inserted into the first locking position 671. The first locking portion 691 can exit the first locking position for unlocking purpose by manually driving the first driving portion 692.

Specifically, one side of the first locking key 69 is provided with an opening mark and a closing mark, the upper connecting seat 6 is provided with a first observation port that allows to observe the marking, and when the first locking portion 691 is in the first locking position 671, the closing marking can be observed from the first observation port, and when the first locking portion 691 is not in the first locking position 671, the opening marking can be observed from the first observation port.

Specifically, the lower connecting seat 7 is directly connected and fixed to the installation position through screws or a buckle structure, or the following embodiments can be referred to: because in the present invention the installation environment is usually an indoor wall, and the bottom of indoor wall is usually provided with a skirting line, causing the distance between the upper connecting seat 6 and the wall different from that between the lower connecting seat 7 and the skirting line, and there's no other way but to increase the installation height of lower connecting seat 7 and, however, a too large height will lead to a too large gap between the lower edge of roller shutter 4 and the ground, through which pets or infants can pass; in order to avoid these problems, in the present embodiment, the column 5 is movably provided with a moving seat 9 for fixed connection with the installation position, and the moving seat can perform reciprocating motion along column 5. When the installation position is a wall with skirting line, as the moving seat 9 can perform reciprocating motion along the support rod 41, the moving seat 9 can be moved to the position above the corresponding skirting line on the wall and fixed in that position, replacing the lower connecting seat 7 fixed in the installation position, and it is unnecessary to adjust the installation height of lower connecting seat 7, and the gap between the lower edge of roller shutter 4 and the ground would not be too large.

Specifically, the moving seat 9 includes a shell 91 and a cover body 92, a groove 911 that fits the pillar 5 is provided on the front side of the shell 91, and the cover body 92 is locked to the front side of shell 91 by a plurality of bolts, and encloses the groove 911 to form a top-open and bottom-open channel that can wrap the pillar 5 partially.

Specifically, a plurality of positioning strips 912 are located on both sides of the corresponding groove 911 on the front side of the shell 91, the position of positioning strip 912 corresponding to the cover body 92 is provided with a positioning groove (not shown in the figure), and the assembly of the shell 91 and cover body 92 enables quick positioning through the cooperation between the positioning strip 912 and the positioning groove (not shown in the figure).

Specifically, the shell 91 has an open bottom, and a bracket 93 is inserted into the shell 91 from bottom to top and locked, the bracket 93 is provided with a nut hole 94 for the bolt to pass through, and a nut for screwing with the bolt is fixed in the nut hole 94.

Specifically, the bracket 93 that is inserted into the shell 91 is locked by screws, and a barb (not shown in the figure) is provided on the side of the bracket 93 near the back of the shell 91, and a hook hole (not shown in the figure) is provided at the position on the back of the shell 91corresponding to the barb for the barb insertion, and the combination of the barb and hook hole can prevent the bracket 93 from falling out from the interior of the shell 91.

Specifically, the back of the moving seat 9 is fixed by double-sided adhesive or locked to the intended installation position by screws, or the following embodiments can be referred to: the moving seat 9 is detachably provided with a second plug board 95 for fixing in the installation position (for example, double-sided adhesive or screws), the back of the moving seat 9 is provided with a second slot (not shown in the figure) for the bottom-top insertion of second plug board 95, the second slot (not shown in the figure) is movably provided with a second locking key 96 having a second locking portion and a second driving portion 961, the second plug board 95 is provided with a second locking position 951 for the insertion of second locking portion, and after the second plug board 95 is inserted into the second slot (not shown in the figure), the second locking portion is inserted into the second slot to limit the second plug board 95 from exiting the second slot (not shown in the figure), and a fourth top spring 97 is additionally provided to apply elastic force to the second locking key 96 to move towards the direction in which the second locking portion is inserted into the second locking position 951. The second locking portion can exit the second locking position 951 for unlocking purpose by manually driving the second driving portion 961.

Specifically, one side of the second locking key 96 is provided with an opening mark and a closing mark, the upper connecting seat 9 is provided with a second observation port that allows to observe the marking, and when the second locking portion 96 is in the second locking position 951, the closing marking can be observed from the first observation port, and when the second locking portion is not in the second locking position 951, the opening marking can be observed from the first observation port.

Specifically, the upper support 1 is installed at the installation position in the same way as the upper connecting seat 6, and the lower support 2 is installed at the installation position in the same way as the moving seat 9. Due to the fact that the rolling shutter door railing and connecting mechanism are assembled by the same buckle structure at the intended installation position, therefore their positions can be freely exchanged to avoid the circumstance where the buckle structure cannot be assembled after position change due to its inadaptability.

Specifically, an upper cover and a seat is assembled to form the upper connecting seat 6.

It should be noted that reference can be made to prior art for other structures of the rolling shutter door railing, and its specific structural principle will not be elaborated here.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

What is claimed is:

1. A rolling shutter door railing, including an upper support (1), a lower support (2), a reel (3) that can be pivotally installed between the upper support (1) and the lower support (2), and a rolling shutter (4) located on the reel (3), also including a connecting mechanism for connecting to the free end of rolling shutter (4), the connecting mechanism includes a column (5) having a seat body for connecting to the installation position, and the column (5) can be vertically fixed to the installation position through the seat, and the connecting mechanism also has a locking mechanism for locking the free end of rolling shutter.

2. The roller shutter door railing according to claim 1, wherein the free end of the roller shutter (4) is provided with a support rod (41), and the seat body includes an upper connecting seat (6) and a lower connecting seat (7) respectively disposed at the top and bottom of support rod (5), the bottom of upper connecting seat (6) and the top of lower connecting seat (7) are respectively provided with a first slot (61) for the insertion of the top of support rod (41) and a second groove (71) for the insertion of the bottom of support rod (41), the locking mechanism is used to lock the support rod (41) with the seat body after the top and bottom of the support rod (41) are respectively inserted into the first slot (61) and the second slot (71).

3. The roller shutter door railing according to claim 2, wherein the locking mechanism includes a first slider (81), and the top wall of the first slot (61) is provided with a vertical extending accommodating groove (60) that fits the first slider (81), the first slider (81) is movably installed in the accommodating groove (60) and can perform vertical reciprocating motion relative to the accommodating groove (60).

4. The roller shutter door railing according to claim 3, wherein a locking member (82) is movably provided at the top of the support rod (41), and the locking member (82) can move between the position where it retracts inside support rod (41) and the position where it extends into the accommodating groove (60) to force the first slider (81) to rise, and the support rod (41) is internally provided with a first top spring (83) connected to the locking member (82), and the first top spring (83) applies elastic force to the locking member (82) so that the first slider (81) can move upward.

5. The rolling shutter door railing according to claim 4, wherein the locking mechanism further includes a second slider (84) and a third slider (85), the second slider (84) is movably installed at the bottom of upper connecting seat (6) and can perform vertical reciprocating motion relative to the upper connecting seat (6), and the upper end of the second slider (84) is located inside the upper connecting seat (6), the third slider (85) is movably installed inside the upper connecting seat (6), and the side of the third slider (85) near the first slider (81) and the side of the third slider (85) near the second slider (84) are respectively provided with a first inclined plane (851) for contact with the first slider (81) and with a second inclined plane (852) for contact with the the top of the second slider (84), the first inclined plane (851) and the second inclined plane (852) have the opposite inclination direction, and the third slider (85) can move between the position where the first slider (81) is forced through the first slope (851) to perform a downward motion and the position where the second slider (84) is forced through the second slope (852) to perform a downward motion.

6. The roller shutter door railing according to claim 5, wherein a guide groove (841) is provided on one side of the second slider (84), and a through groove (62) is provided at the bottom of upper connecting seat (6) for the second slider (84) to vertically pass through, the through groove (62) is connected to the interior of upper connecting seat (6), and a first limit portion (63) that can extend into the guide groove (841) is provided in the through groove (62), and the first limit portion (63) can maintain contact with the top of guide groove (841) to limit the second slider (84) to detach from the through groove (62).

7. The roller shutter door railing according to claim 6, wherein a second top spring (86) is provided in the guide groove (841), and the upper and lower ends of the second top spring (86) are respectively pressed against the bottom wall of upper connecting seat (6) and the bottom wall of guide groove (841), the second top spring (86) can be used to apply elastic force to the second slider (84) so that the second slider (84) can move to exit the through groove (62).

8. The roller shutter door railing according to claim 5, wherein the top wall of the third slider (85) is provided with a first mark (853) and a second mark (854) that are disposed adjacently, and the top wall of the upper connecting seat (6) is provided with an observation window (64) that is connected with the interior of upper connecting seat (6), and when the third slider (85) moves to push the locking member (82) into the support rod (41), the first mark (853) is aligned up and down with the observation window (64); the third slider (85) moves until the locking member (82) extends into the accommodating groove (60), and then the second mark (854) is aligned up and down with the observation window (64).

9. The roller shutter door railing according to claim 5, wherein bottom-open and top-open moving channels (65) are respectively provided inside the upper connecting seat (6) corresponding to the positions above and below the third slider (85), the top and bottom walls of the third slider (85) are provided with guiding portions (855) that can insert the two moving channels (65) respectively, and the third slider (85) can move along the moving channel (65) based on the cooperation between the guiding portion (855) and the moving channel (65).

10. The roller shutter door railing according to claim 4, wherein the first slot (61) is provided with a pressure groove (611) that is partially open for the top of support rod (41) to pass through and that has a slanted extended pressure groove (611) at the open position and, when the support rod (41) passes through the open position, the pressure groove (611) can be used to gradually push the locking member (82) into the interior of support rod (41).

11. The roller shutter door railing according to claim 5, wherein a locking position (66) is provided inside the upper connecting seat (6) corresponding to the top of accommodating groove (60), and a second limit portion (811) is provided at the top of the first slider (81) that can be pressed against with the locking position (66) up and down to prevent the complete entry of first slider (81) into the accommodating groove (60).

12. The roller shutter door railing according to claim 2, wherein the edge of the free end of roller shutter (4) is provided with a kit (42) for wrapping the support rod (41), and a cap body (43) is additionally provided for the end of support rod (41) to insert and, after the kit (42) wraps the support rod (41), the cap body (43) will wrap and fix the top of support rod (41) and of kit (42), and wrap and fix the bottom of support rod (41) and of kit (42).

13. The roller shutter door railing according to claim 2, wherein a window (44) is provided at the free end of roller shutter (4) near support rod (41) for easy gripping of the support rod (41).

14. The roller shutter door railing according to claim 2, wherein the upper connecting seat (6) is detachably provided with a first plug board (67) for fixing in the installation position, the back of upper connecting seat (6) is provided with a first slot (68) for the bottom-top insertion of the first plug board (67), the first slot (68) is movably provided with a first locking key (69) having a first locking portion (691) and a first driving portion (692), the first plug board (67) is provided with a first locking position (671) for the insertion of first locking portion (691), and after the first plug board (67) is inserted into the first slot (68), the first locking portion (691) is inserted into the first locking position (671) to limit the first plug board (67) from exiting the first slot (68), and a third top spring (693) is additionally provided to apply elastic force to make the first locking key (69) to move towards the direction in which the first locking portion (691) is inserted into the first locking position (671).

15. The roller shutter door railing according to claim 14, wherein the pillar (5) is movably sleeved with a moving seat (9) for fixed connection with the installation position, and the moving seat (9) can move back and forth along the pillar (5).

16. The rolling shutter door railing according to claim 15, wherein the moving seat (9) includes a shell (91) and a cover body (92), a groove (911) that fits the pillar (5) is provided on the front side of the shell (91), and the cover body (92) is locked to the front side of shell (91) by a plurality of bolts, and encloses the groove (911) to form a top-open and bottom-open channel that can wrap the pillar (5) partially.

17. The roller shutter door railing according to claim 15, wherein the shell (91) has an open bottom, and a bracket (93) is inserted into the shell (91) from bottom to top and locked, the bracket (93) is provided with a nut hole (94) for the bolt to pass through, and a nut for screwing with the bolt is fixed in the nut hole (94).

18. The roller shutter door railing according to claim 15, wherein the moving seat (9) is detachably provided with a second plug board (95) for fixing in the installation position, the back of the moving seat (9) is provided with a second slot for the bottom-top insertion of second plug board (95), the second slot is movably provided with a second locking key (96) having a second locking portion and a second driving portion (961), the second plug board (95) is provided with a second locking position (951) for the insertion of second locking portion, and after the second plug board (95) is inserted into the second slot, the second locking portion is inserted into the second slot to limit the second plug board (95) from exiting the second slot, and a fourth top spring (97) is additionally provided to apply elastic force to the second locking key (96) to move towards the direction in which the second locking portion is inserted into the second locking position (951).

19. The roller shutter door railing according to claim 18, wherein the upper support (1) is installed at the installation position in the same way as the upper connecting seat (6), and the lower support (2) is installed at the installation position in the same way as the moving seat (9).
